(19) United States
(12) Patent Application Publication
(10) Pub. No.: US 2011/0124357 A1
(43) Pub. Date: May 26, 2011

(54) METHOD AND APPARATUS OF CONTENTION BASED UPLINK TRANSMISSION IN MOBILE COMMUNICATION SYSTEM

(75) Inventors: Kyung Sook KIM, Daejeon (KR); Jae Sheung SHIN, Daejeon (KR); Hyun Seo PARK, Daejeon (KR)

(73) Assignee: Electronics and Telecommunications Research Institute, Daejeon (KR)

(21) Appl. No.: 12/954,159

(22) Filed: Nov. 24, 2010

(30) Foreign Application Priority Data
Nov. 24, 2009 (KR) 10-2009-0113783
Jul. 22, 2010 (KR) 10-2010-0070981

(51) Int. Cl. H04B 7/00

(52) U.S. Cl. 455/507

(57) ABSTRACT

A contention based uplink transmission method may perform an uplink transmission using a radio resource corresponding to a contention based identity, for example, a contention based cell-radio network temporary identity (CB C-RNTI) suitable for the uplink transmission of a user equipment, based on radio channel quality and a size of uplink data desired to be transmitted.

### CROSS-REFERENCE TO RELATED APPLICATIONS

This application claims the benefit of Korean Patent Application No. 10-2009-0113783, filed on Nov. 24, 2009, and Korean Patent Application No. 10-2010-0070981, filed on Jul. 22, 2010, in the Korean Intellectual Property Office, the disclosures of which are incorporated herein by reference.

### BACKGROUND

1. Field of the Invention

The present invention relates to a transmission method and apparatus in a mobile communication system, and more particularly, to a method and apparatus for a contention based uplink transmission in a mobile communication system.

2. Description of the Related Art

FIG. 1 is a diagram illustrating an uplink data transmission through a scheduling request.

Referring to FIG. 1, in a 3^{rd} Generation Partnership Project (3GPP) Long Term Evolution (LTE) system, when a physical uplink shared channel (PUSCH) resource does not exist at a point in time 102 when a user equipment 100 requests an uplink transmission, the user equipment 100 may transmit a scheduling request 104 to an evolved nodeB (eNodeB) 120. In response to the scheduling request 104, the eNodeB 120 may transmit, to the user equipment 100, PUSCH resource assignment information (UL Grant) 106 for uplink data transmission.

When the user equipment 100 receives the PUSCH resource assignment information (UL Grant) 106 from the eNodeB 120, the user equipment 100 may perform uplink data transmission 108 with respect to the eNodeB 120.

According to a conventional art, in a 3GPP LTE system, when a PUSCH resource does not exist at a point in time when a user equipment requests an uplink data transmission, the user equipment may transmit a scheduling request and then need to wait until UL grant corresponding to a contention-free based uplink transmission to a user equipment identity, that is, cell-radio network temporary identity (C-RNTI) is received. Accordingly, when the user equipment shifts from a dormant state to an active state, a time delay may occur. In the 3GPP LTE system, a radio channel of each of a plurality of user equipments desiring to perform uplink data transmission may have a different quality. Each of the user equipments may have a different amount of data available for transmission in the uplink buffers of the UE.

### SUMMARY

An aspect of the present invention provides a method and apparatus for a contention based uplink transmission that may perform uplink transmission using a radio resource corresponding to a contention based identity, for example, a contention based cell-radio network temporary identity (CB C-RNTI) suitable for an uplink transmission of the user equipment.

According to an aspect of the present invention, there is provided a method for a contention based uplink transmission, including: generating a contention based cell-radio network temporary identity (CB C-RNTI) list including at least one CB C-RNTI for a contention based uplink transmission of a user equipment; receiving downlink control information corresponding to each of the at least one CB C-RNTI through a physical downlink control channel (PDCCH; selecting a target CB C-RNTI from the at least one CB C-RNTI based on the downlink control information and a transmission criterion of the contention based uplink of the user equipment; and performing the contention based uplink transmission using resource assignment intended for the target CB C-RNTI.

According to another aspect of the present invention, there is provided an apparatus for a contention based uplink transmission, including: a list manager to manage a contention based cell-radio network temporary identity (CB C-RNTI) list including at least one CB C-RNTI for a contention based uplink transmission of a user equipment; a receiver to receive downlink control information corresponding to each of the at least one CB C-RNTI through a physical downlink control channel (PDCCH); a selector to select a target CB C-RNTI from the at least one CB C-RNTI based on the downlink control information and a transmission criterion of the contention based uplink of the user equipment; and a data transmitter to perform the contention based uplink transmission using resource assignment intended for the target CB C-RNTI.

According to embodiments of the present invention, it is possible to enhance a transmission and reception performance when performing a contention based uplink transmission, and to decrease a delay time when a user equipment shifts from a dormant state to an active state.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an uplink data transmission through a scheduling request;

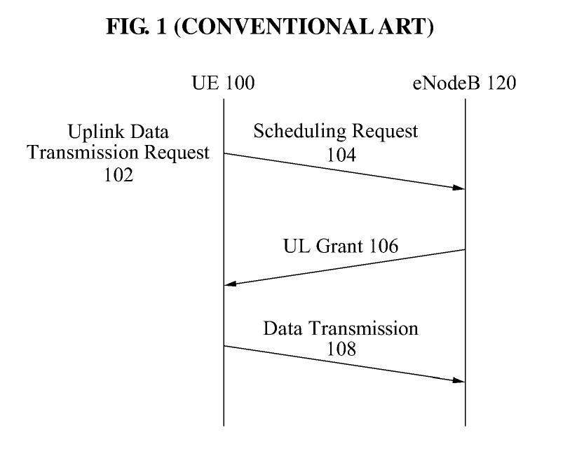

FIG. 2 is a flowchart illustrating a data transmission method of a contention based uplink according to an embodiment of the present invention;

FIG. 3 is a diagram illustrating a contention based uplink transmission according to an embodiment of the present invention; and

FIG. 4 is a block diagram illustrating a contention based uplink transmission apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

In a mobile communication system, a user equipment may receive control information from an evolved nodeB (eNodeB) that is a base station, through a downlink. The user equipment may transmit information through an uplink. The user equipment may be a mobile terminal.

Information transmitted from or received by the user equipment may include data and a variety of control information. Various types of physical channels may exist based on a type or a purpose of the information transmitted from or received by the user equipment.

When the user equipment is powered on in a power-off state of the user equipment, or when the user equipment newly enters a cell, the user equipment may perform an initial cell searching operation such as matching synchronization with the eNodeB. For the above operation, the user equipment may acquire synchronization between the user equipment and the eNodeB using a synchronization channel from the eNodeB, and may acquire information of a cell ID and the like. Next, the user equipment may receive a physical broadcast channel from the eNodeB to acquire broadcast information within a cell.

In the initial cell searching operation, the user equipment may receive a downlink reference signal (DL RS) to verify a downlink channel state.

The user equipment having completed the initial cell search may acquire more specific system information using a physical downlink shared channel (PDSCH).

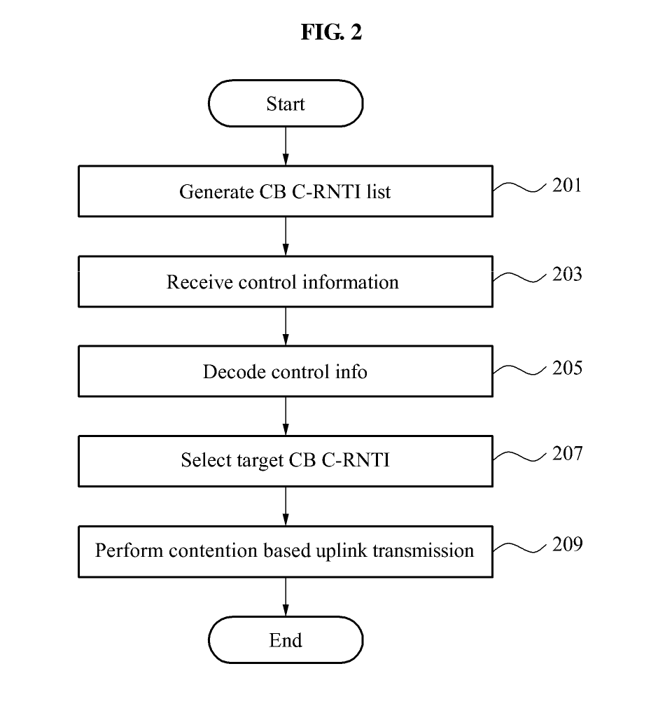

FIG. 2 is a flowchart illustrating a data transmission method of a contention based uplink according to an embodiment of the present invention.

An eNodeB may define a plurality of contention based cell-radio network temporary identities (CB C-RNTIs) for a contention based uplink transmission. Here, the plurality of CB C-RNTIs may be defined based on a quality of a radio channel and a size category of an uplink transmission data.

In addition, each of the resource assignment intended for the CB C-RNTIs may support a modulation and coding scheme (MCS) and a physical resource block (PRB) assignment that is based on a quality of the radio channel and a size of an uplink transmission data.

Referring to FIG. 2, in a mobile communication system including a Long Term Evolved (LTE)-Advanced system, a user equipment may generate a CB C-RNTI list including at least one CB C-RNTI for the contention based uplink transmission in operation 201.

The CB C-RNTI list may be assigned from the eNodeB to the user equipment.

In operation 203, the user equipment may receive downlink control information corresponding to each of the at least one CB C-RNTI through a physical downlink control channel (PDCCH) corresponding to the contention based uplink.

The downlink control information corresponding to each of the at least one CB C-RNTI may include an MCS and transport block size information, for example, PRB assignment information that are used for the contention based uplink transmission.

The user equipment may determine a size of a transport block of the contention based uplink based on the downlink control information.

In operation 205, the user equipment may decode the downlink control information corresponding to each of the at least one CB C-RNTI.

Specifically, when downlink control information for a contention-free based uplink transmission for the user equipment does not exist at a point in time when the user equipment requests a uplink data transmission, the user equipment may decode downlink control information corresponding to each of the at least one CB C-RNTI.

The decoded downlink control information may include information associated with a resource assignment of a physical uplink shared channel (PUSCH) corresponding to each of the at least one CB C-RNTI.

Also, the user equipment may verify a modulation scheme of uplink transmission data among a quadrature phase shift keying (QPSK) scheme, 16 quadrature amplitude modulation (QAM), and 64QAM based on decoded information, and transport block size information of the contention based uplink.

In operation 207, the user equipment may select a target CB C-RNTI from the at least one CB C-RNTI based on the downlink control information and a transmission criterion of the contention based uplink of the user equipment.

Here, the downlink control information may include an MCS used for the contention based uplink transmission, and PRB assignment information. Accordingly, the user equipment may determine a size of a transport block of the contention based uplink based on the downlink control information.

The user equipment may select a target CB C-RNTI suitable for an uplink transmission of the user equipment, based on whether the downlink control information, for example, the MCS and transport block size information corresponding to each of the at least one CB C-RNTI satisfies a transmission criterion of the contention based uplink.

Here, the transmission criterion of the contention based uplink may include a criterion associated with a radio channel quality of the user equipment and a criterion associated with a size of uplink data desired to be transmitted by the user equipment.

For example, in operation 207, the user equipment may select a target CB C-RNTI of which MCS information corresponding to each of the at least one CB C-RNTI is less than or equal to a code rate suitable for a radio channel quality of the user equipment.

When at least two CB C-RNTIs satisfy the transmission criterion of the contention based uplink, the user equipment may select, as the target CB C-RNTI, a CB C-RNTI of which transport block size information corresponding to each of the at least two CB C-RNTIs maximizes a transmission of uplink data desired to be transmitted by the user equipment.

In operation 209, the user equipment may perform the contention based uplink transmission using the target CB C-RNTI.

In this instance, the user equipment may perform the contention based uplink transmission using a radio resource assignment corresponding to the target CB C-RNTI.

Also, in operation 209, the user equipment may transmit identity information, for example, C-RNTI information of the user equipment and buffer status report information using a contention based uplink transmission.

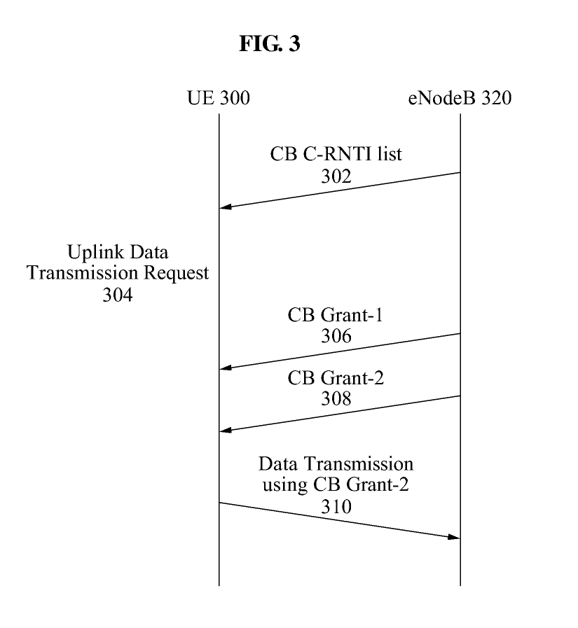

FIG. 3 is a diagram illustrating a contention based uplink transmission according to an embodiment of the present invention.

Referring to FIG. 3, a user equipment 300 may generate a CB C-RNTI list 302 assigned from an eNodeB 320 for the contention based uplink transmission. Here, the CB C-RNTI list 302 may include at least one CB C-RNTI.

Here, it is assumed that CB C-RNTI 1 and CB C-RNTI 2 are included in the CB C-RNTI list 302. When the user equipment 300 requests a data transmission 304 to a contention based uplink, and when downlink control information for a contention-free based uplink transmission for the user equipment 300 does not exist, the user equipment 300 may receive, from the eNodeB 320, and decode downlink control information, for example, CB Grant-1 306 corresponding to CB C-RNTI 1 and CB Grant-2 308 corresponding to CB C-RNTI 2.

The decoded information may include information associated with an MCS, a PRB assignment, and the like with respect to each of CB C-RNTI 1 and CB C-RNTI 2.

The user equipment 300 may select one of CB C-RNTI 1 and CB C-RNTI 2 that is suitable for the contention based uplink transmission of the user equipment.

A CB C-RNTI may be selected based on downlink control information corresponding to each of CB C-RNTI 1 and CB C-RNTI 2, and whether a transmission criterion of contention based uplink of the user equipment is satisfied.

When CB C-RNTI 2 is determined to be more suitable as shown in FIG. 3, the user equipment 300 may determine CB C-RNTI 2 as a target CB C-RNTI. The user equipment 300 may perform a contention based uplink transmission 310 using a radio resource corresponding to the target CB C-RNTI.

Although two CB C-RNTIs are included in the CB C-RNTI list in FIG. 3, the present invention is not limited thereto. A plurality of CB C-RNTIs may be included in the CB C-RNTI list.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

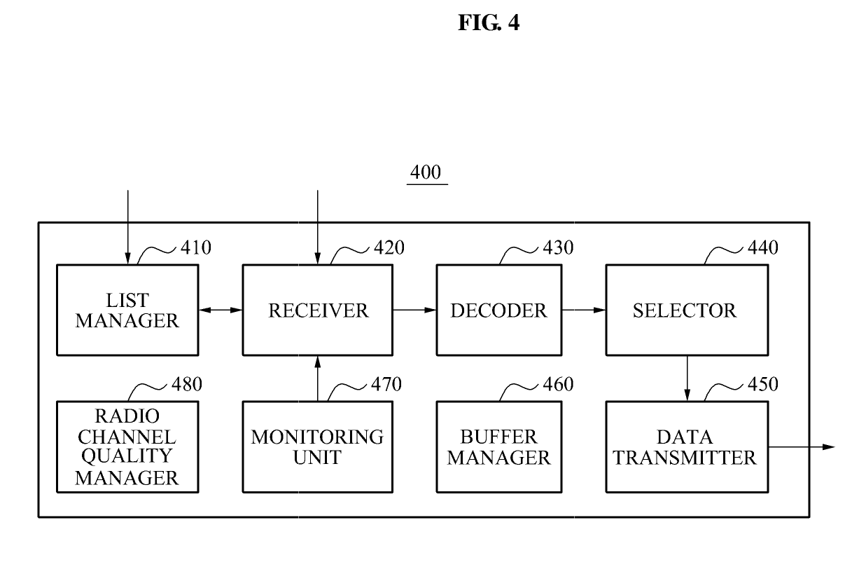

FIG. 4 is a block diagram illustrating a contention based uplink transmission apparatus 400 according to an embodiment of the present invention.

Referring to FIG. 4, the contention based uplink transmission apparatus 400 may include a list manager 410, a receiver 420, a decoder 430, a selector 440, and a data transmitter 450.

The contention based uplink transmission apparatus 400 may further include a buffer manager 460, a monitoring unit 470, and a radio channel quality manager 480.

The contention based uplink transmission apparatus 400 may be configured as a user equipment, for example, a mobile terminal, and may also be combined with the user equipment as a separate apparatus and thereby be used.

The list manager 410 may generate a CB C-RNTI list including at least one CB C-RNTI for a transmission of a contention based uplink of the user equipment.

The receiver 420 may receive downlink control information corresponding to each of the at least one CB C-RNTI through a PDCCH corresponding to the contention based uplink.

The downlink control information corresponding to each of the at least one CB C-RNTI may include an MCS and transport block size information that are used for the contention based uplink transmission. Accordingly, the contention based uplink transmission apparatus 400 may determine a size of a transport block of the contention based uplink based on the downlink control information.

When downlink control information for a contention-free based uplink transmission for the user equipment does not exist at a point in time when the user equipment requests a data transmission, the decoder 430 may decode downlink control information corresponding to each of the at least one CB C-RNTI.

Here, a case where downlink control information for the contention-free based uplink transmission for the user equipment does not exist corresponds to a case where the uplink resource assignment information corresponding to the C-RNTI of the user equipment does not exist.

The selector 440 may select a target CB C-RNTI from the at least one CB C-RNTI based on the downlink control information corresponding to each of the at least one CB C-RNTI and a transmission criterion of the contention based uplink.

Here, the downlink control information may include an MCS and transport block size information that are used for the contention based uplink transmission.

In addition, the selector 440 may select the target CB C-RNTI based on whether the transmission criterion of the contention based uplink is satisfied based on the downlink control information, radio channel quality information of the user equipment, and size information of uplink data desired to be transmitted.

The transmission criterion of the contention based uplink of the user equipment may include a criterion associated with a radio channel quality of the user equipment and a criterion associated with a size of uplink data desired to be transmitted by the user equipment.

The data transmitter 450 may perform the contention based uplink transmission using the target CB C-RNTI.

The data transmitter 450 may perform the contention based uplink transmission using a radio resource corresponding to the target CB C-RNTI.

When the user equipment requests the uplink data transmission, the data transmitter 450 may perform the contention based uplink transmission using the radio resource corresponding to the selected target CB C-RNTI. Here, the radio resource may include information associated with the MCS and a PRB.

The data transmitter 450 may transmit C-RNTI information of the user equipment and buffer status report information using the contention based uplink transmission.

The buffer manager 460 may manage a size of uplink data desired to be transmitted by the user equipment, or a size of a uplink buffer.

The monitoring unit 470 may monitor a PDCCH corresponding to the at least one CB C-RNTI in order to receive downlink control information corresponding to each of the at least one CB C-RNTI included in the CB C-RNTI list.

The radio channel quality manager 480 may manage a radio channel quality of the user equipment.

The radio channel quality manager 480 may update the radio channel quality at intervals of at least one subframe.

Although omitted hereinafter, descriptions associated with the contention based uplink transmission method described above with reference to FIG. 2 and FIG. 3, and description associated with the contention based uplink transmission apparatus described with reference to FIG. 4 may refer to each other.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for a contention based uplink transmission, comprising:
generating a contention based cell-radio network temporary identity (CB C-RNTI) list comprising at least one CB C-RNTI for a contention based uplink transmission of a user equipment;
receiving downlink control information corresponding to each of the at least one CB C-RNTI through a physical downlink control channel (PDCCH) corresponding to the contention based uplink;
selecting a target CB C-RNTI from the at least one CB C-RNTI based on the downlink control information and a transmission criterion of the contention based uplink of the user equipment; and
performing the contention based uplink transmission using the target CB C-RNTI.

2. The method of claim 1, further comprising:
decoding the downlink control information corresponding to each of the at least one CB C-RNTI,
wherein when downlink control information for a contention-free based uplink transmission for the user equipment does not exist at a point in time when the user equipment requests a uplink data transmission, downlink control information corresponding to each of the at least one CB C-RNTI is decoded.

3. The method of claim 1, wherein the selecting comprises selecting the target CB C-RNTI, based on whether the downlink control information corresponding to each of the at least one CB C-RNTI satisfies the transmission criterion of the contention based uplink.

4. The method of claim 3, wherein the transmission criterion of the contention based uplink comprises a criterion associated with a radio channel quality of the user equipment and a criterion associated with a size of uplink data desired to be transmitted by the user equipment.

5. The method of claim 1, wherein:
the downlink control information comprises a modulation and coding scheme (MCS) and physical resource block assignment information that are used for the contention based uplink transmission, and
a size of a transport block of the contention based uplink is determined based on the downlink control information.

6. The method of claim 1, wherein the performing comprises performing the contention based uplink transmission using a radio resource corresponding to the target CB C-RNTI.

7. The method of claim 1, wherein the performing comprises transmitting C-RNTI information of the user equipment and buffer status report information using the contention based uplink transmission.

8. An apparatus for a contention based uplink transmission, comprising:
a list manager to generate a contention based cell-radio network temporary identity (CB C-RNTI) list comprising at least one CB C-RNTI for a contention based uplink transmission of a user equipment;
a receiver to receive downlink control information corresponding to each of the at least one CB C-RNTI through a physical downlink control channel (PDCCH) corresponding to the contention based uplink;
a selector to select a target CB C-RNTI from the at least one CB C-RNTI based on the downlink control information and a transmission criterion of the contention based uplink of the user equipment; and
a data transmitter to perform the contention based uplink transmission using the target CB C-RNTI.

9. The apparatus of claim 8, further comprising:
a decoder to decode the downlink control information corresponding to each of the at least one CB C-RNTI,
wherein when downlink control information for a contention-free based uplink transmission for the user equipment does not exist at a point in time when the user equipment requests a uplink data transmission, the decoder decodes downlink control information corresponding to each of the at least one CB C-RNTI.

10. The apparatus of claim 8, further comprising:
a monitoring unit to monitor a PDCCH corresponding to the at least one CB C-RNTI in order to receive the downlink control information corresponding to each of the at least one CB C-RNTI included in the CB C-RNTI list.

11. The apparatus of claim 8, further comprising:
a radio channel quality manager to manage a radio channel quality of the user equipment.

12. The apparatus of claim 11, wherein the radio channel quality manager updates the radio channel quality at intervals of at least one subframe.

13. The apparatus of claim 8, further comprising:
a buffer manager to manage a size of uplink data desired to be transmitted the user equipment.

14. The apparatus of claim 8, wherein the selector selects the target CB C-RNTI, based on whether the downlink control information corresponding to each of the at least one CB C-RNTI satisfies the transmission criterion of the contention based uplink.

15. The apparatus of claim 14, wherein the transmission criterion of the contention based uplink comprises a criterion associated with a radio channel quality of the user equipment and a criterion associated with a size of uplink data desired to be transmitted by the user equipment.

16. The apparatus of claim 15, wherein:
the downlink control information comprises a modulation and coding scheme (MCS) and transport block size information that are used for the contention based uplink transmission, and
the selector selects the target CB C-RNTI based on whether the transmission criterion of the contention based uplink is satisfied based on the downlink control information, radio channel quality information of the user equipment, and size information of uplink data desired to be transmitted.

17. The apparatus of claim 8, wherein:
the downlink control information comprises an MCS used for the contention based uplink transmission, and physical resource block assignment information, and
a size of a transport block of the contention based uplink is determined based on the downlink control information.

18. The apparatus of claim 8, wherein the data transmitter performs the contention based uplink transmission using a radio resource corresponding to the target CB C-RNTI.

19. The apparatus of claim 8, wherein the data transmitter transmits C-RNTI information of the user equipment and buffer status report information using the contention based uplink transmission.
